(19) United States
(12) Patent Application Publication
(10) Pub. No.: US 2018/0160153 A1
(43) Pub. Date: Jun. 7, 2018

(54) SYSTEM AND METHOD FOR LIVE STREAMING CONTENT TO SUBSCRIPTION AUDIENCES USING A SERVERLESS COMPUTING SYSTEM

(71) Applicant: Whalerock Industries, LLC, West Hollywood, CA (US)

(72) Inventor: Jeff Rajewski, West Hollywood, CA (US)

(73) Assignee: Whalerock Industries, LLC, West Hollywood, CA (US)

(21) Appl. No.: 15/369,473

(22) Filed: Dec. 5, 2016

(51) Int. Cl. H04N 21/2187; H04L 29/08; H04N 21/488; H04N 21/4223; H04N 21/2543; H04N 21/4185

(52) U.S. Cl. CPC H04N 21/2187; H04L 67/26; H04N 21/4185; H04N 21/4223; H04N 21/2543; H04N 21/4882

(57) ABSTRACT

A serverless subscription service and method for a subscription service which verifies subscription statuses of devices across multiple platforms and aggregates event data from those multiple platforms into normalized, multi-format event data. An exemplary serverless subscription service can issue a notification that a live video streaming event is beginning, then initiate streaming of the live video streaming event to user devices, where the resolution of the live video depends on if the user is a subscriber. The subscription service can also receive, during the live video streaming event, event data from the user device, where the event data has characteristics specific to the platforms of the devices. The subscription service can then aggregate the event data across the multiple platforms to form multi-format event streaming data.

### BACKGROUND

### 1. Technical Field

The present disclosure relates to live streaming content to subscription audiences using a serverless computing system, and more specifically to using a serverless computing system to authorize content distribution to authorized subscribers.

### 2. Introduction

As forms of social media expand, the live streaming of media content, such as audio and video, to private audiences continues to play a larger role in public life. Due to the variety of media platforms and formats which exist (for example, iOS™, Android™, and Amazon™ platforms), operating a subscription service which distributes live content simultaneously across those platforms, while obtaining meaningful information about the distribution, presents multiple technical challenges. While many platforms allow common data formats for streaming content, such as HLS (HTTP Live Steaming), current services fail to provide for live streaming content to be delivered exclusively to subscribers while providing mechanisms for non-subscribers to be given samples of the live streaming content.

### SUMMARY

A method for issuing, via a serverless computing system, a notification that a live video streaming event is beginning; initiating streaming of the live video streaming event to a first device at a first resolution, wherein the first resolution is based on a first subscription status associated with the first device; initiating streaming of the live video streaming event to a second device at a second resolution, wherein the second resolution is a reduced version from the first resolution, and wherein the second resolution is based on a second subscription status associated with the second device; receiving, during the live video streaming event, first event data from the first device and second event data from the second device; and aggregating the first event data with the second event data to form multi-format event streaming data.

A serverless subscription service configured to perform operations, the operations comprising: issuing a notification that a live video streaming event is beginning; initiating streaming of the live video streaming event to a first device at a first resolution, wherein the first resolution is based on a first subscription status associated with the first device; initiating streaming of the live video streaming event to a second device at a second resolution, wherein the second resolution is a reduced version from the first resolution, and wherein the second resolution is based on a second subscription status associated with the second device; receiving, during the live video streaming event, first event data from the first device and second event data from the second device; and aggregating the first event data with the second event data to form multi-format event streaming data.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example system embodiment;

FIG. 2 illustrates and example method embodiment;

FIG. 3 illustrates an exemplary computer architecture; and

FIG. 4 illustrates an exemplary microservices architecture.

### DETAILED DESCRIPTION

The present disclosure addresses live streaming media content via a subscription service in a serverless computing environment. More specifically, the serverless subscription services disclosed herein are Internet-based subscription services where subscribers access content behind a paywall using their handheld devices (smart phones, tablets, etc.), web browsers, TV-connected devices, etc. To access live streaming media content on those devices, subscribers pay a subscription fee. The live streaming media content can be provided from anywhere, at any time, to the subscription audience where the subscription audience uses devices from a variety of platforms. The subscription service can then analyze data associated with the live stream to identify conversion, retention, engagement, Quality of Service (QoS) attributes, and influences on the subscriber and non-subscriber audience.

The anyplace, anytime nature of the live streaming capacity allows content providers to be on the move as they begin streaming live content. The live stream can then be accessed by subscribers, while the subscription service begins recording data associated with the live stream event. For example, the subscription service can record information such as how soon after a notification that an event is starting the users begin viewing the content, view rates, conversion rates, retention during the event, etc. This information can be recorded in a database and used to provide a more complete view of the life cycle of subscribers. For example, the database can provide information about when a subscriber joined the service, how often the subscriber used the service, and when the subscriber declines to renew the service. In addition, such data can be combined with advertising, network, and/or Quality of Service (QoS) information, to develop insight into why subscribers joined (or declined to renew) when they did.

The live streaming can use a platform agnostic content protocol, such as HLS (HTTP Live Streaming), to send data to user devices. In other words, whether users are using an iOS device, an Android device, or an alternative device, valid subscribers will be able to view the live stream event. However, broadcasting to multiple platforms can make the ability to identify cross-platform trends and behavior in how the live content is being received difficult.

Subscription services configured according to this disclosure are serverless. For example, the subscription service will utilize web services, such as AMAZON WEB SERVICES (AWS), to perform functions and operations. While the web services utilize computers and servers to operate, use of such services is considered “serverless” because the subscription service itself does not own, maintain, or operate the servers. Instead, the subscription service pays the web service for when subscription service operations are being performed by the web service servers. The web service can have the ability to load balance as needed, allowing the subscription service to scale according to need in real-time (i.e., within minutes or seconds), while only paying for time where operations of the subscription service are being performed by the web service servers. While the subscription service itself is serverless, the subscription service can use third-party services which are not serverless.

The serverless subscription services as disclosed herein allow content providers to stream live content via an administration application (“admin app”). Content providers can also record and upload video content to a media server for later, on-demand playback by the subscription audience. End users can access live content being streamed by the content provider through a consumer app. A person initiating a live stream (such as an individual/celebrity initiating a live video stream, or the designated representative of an organization beginning the live video stream) could access the admin app through a mobile device, such as a smartphone, tablet, laptop, or other mobile computing device, at any time and from any place. The admin app can service multiple brand and subscription services by using the content provider's login credentials to connect to the correct audience/consumer app. The admin app can check to see if conditions are favorable to live streaming before allowing the content provider to proceed with the stream. For example, the admin app can perform a bandwidth check and, if the content provider is in a location with low bandwidth, or if the content provider's device has a low battery, the admin app can suggest to the content provider that they not proceed, or even prevent the content provider from proceeding altogether. In some conditions, the content provider may be able to override the admin app recommendations, whereas in other conditions the content provider may not be able to override the recommendation (and therefore the content provider will not be permitted to stream until network conditions improve). The admin app can direct the video to a media server which renders the live video stream into multiple formats—a full version for subscribers and a reduced (thumbnail) version for non-subscribers. The admin app can also provide enhancement to content being streamed or recorded, thereby allowing content providers to add text / graphical overlays to the live stream in progress at any time they desire. An example of this would be the content provider deciding to blow a kiss to the audience at a certain point in the stream. He/she will do so through use of the admin app, choosing the desired text/graphic from available options, and then pushing it into the video stream at the desired time. Viewers will see a “kiss” graphic. In certain configurations, viewers may have access to a limited number of reaction text/graphic responses. In those configurations, audience members can send “hearts” back to the content provider and the video stream will display a count of all “hearts” sent by the audience during a certain time interval.

The subscription service, upon receiving a notification from the media server, can issue a notification to end-users of the consumer app, who are considered end-users herein because they are the final receivers of the live stream content. This notification can be, for example, a push notification, where the notification appears on the home screen of the user's mobile device. In other configurations, the notification can be an email, a pre-recorded message delivered to the user's phone number, or a calendar reminder. The notification can be sent to all users (that is, all users who have opted in to receive notifications) or to a specified segment of users (e.g., exclusive messaging to Gold Star subscribers, all current subscribers, all former/no longer current subscribers, etc.). Such exclusive notification messaging doesn't prevent other users from accessing the stream if they happen to be in the app at the time. When the users receive the notification, they can open the app on their phone, computer, or other computing device, to begin viewing the live streaming content.

Any user of the consumer app can receive a notification that a live stream is in progress. When the user swipes through (in the case of a push notification), or otherwise indicates to open the app, they will be taken to the app's home screen, which can have the live stream playing at thumbnail size with no audio. The user can then decide whether to click in to the live stream video in progress. If they click in and if they are a subscriber, the video will render full screen with audio. If they click in and if they are not a subscriber, the user will be directed to the subscription signup page.

With the live stream content being displayed on the computing device (such as a smartphone) of the user, the subscription service can monitor not only how many individuals are receiving the live stream, but also how those individuals are receiving the live stream. For example, the subscriptions service can receive metrics the entire group of subscribers or from each individual subscriber watching the live stream. Such metrics can indicate, for example, how well the live stream is being delivered from the content provider to the media server, how well the media server is delivering the live stream to the individual subscribers (i.e., packet loss, dropped connections, lag, audio loss, etc.), and the number of individuals that join/drop the live stream at various points during streaming. Other metrics may be unrelated to QoS of the live stream. For example, the metrics may be used to determine which live streams led to the most subscription conversions and why, or which live streams may have contributed to cancellations. The data can also yield insight into which live streams the most shared, the most discussed, in various time frames (i.e., during the live event, during a post-event on-demand playback, etc.).

If the subscription service detects that the live stream is not being properly delivered to the media server, or that the subscribers are not receiving the live stream at a desired quality (i.e., dropped packets), the subscription service can take measures to temporarily remedy the circumstance. For example, the subscription service can identify that the stream is not being properly delivered from the administration app to the media server, with the result being that the subscribers are not receiving a proper live stream feed. To correct for this, the subscription service can initiate streaming of “place holder” or “filler” content to play until the proper live stream becomes available. For example, if the content provider loses sufficient bandwidth to continue a live stream of video content, the subscription service can detect that the media server is not properly receiving the live stream and substitute, to the subscribers, a video indicating that the live stream will return momentarily. Alternatively, the subscription service may determine that the overall video quality being provided should be lowered based on the number of packets being received across multiple devices. In another example, if the subscription service identifies, based on feedback metrics from the subscribers, that a live audio stream is corrupted or otherwise not being received correctly, the subscription service can temporarily play a placeholder audio file, indicating the live stream will return shortly. As an additional example, operators of the subscription service can choose to replace the live stream with a placeholder stream if circumstances require it. For example, if either the QoS reaches an unsatisfactory level of degradation, if the content of the live stream violates policies, or if a hostile actor gained control of the stream from the authorized content provider, subscription service operators could modify the stream. Making these determinations can be based on the data for the live stream not meeting pre-determined thresholds. The thresholds can be assigned to a tiered level of presentation, where if the subscription service identifies that the quality of the live stream does not meet the required quality for a particular tier because of missing packets, the quality of the live stream can be dropped to a lower tier. When the content provider ends the live stream (which they can do at any time), the live streaming content can be replaced with previously generated post-event content. For example, if the live streaming content were a video, the post-event content displayed can be a short video or graphic, thanking the users for participating. Alternatively, the video play delivering the live stream may close after a pre-configured amount of time following the end of the event, leaving the user free to explore other content and features of the consumer app.

The subscription service can also provide services to allow the subscribers to view previously recorded live events. In some cases, these previously recorded live events may be an unedited version of the live stream which was stored in the media server. In other cases, the previously recorded live stream may have been edited. For example, after the live stream ends, the content provider may indicate that they did not like certain portions of the live stream, and ask that such portions be removed from the edited/saved version of the live stream recording. As a user later views the edited recording, the removed portions will not be in the recording. The subscription service can continue receiving metrics regarding viewer behavior while presenting the recorded content, including receiving data such as how much of the content the viewer watches, how the content is being received by the viewer's device (i.e., if the viewer's device is receiving all of the intended packets), the contribution of the recorded content to subscription conversions, subscriber retention and churn measurements, etc.

Having provided an overarching description, the disclosure turns to specific embodiments and configurations as illustrated in the figures. While specific implementations are described, it should be understood that this is done for illustration purposes only. Other components and configurations may be used without parting from the spirit and scope of the disclosure, and portions of exemplary configurations may be used with other configurations as desired.

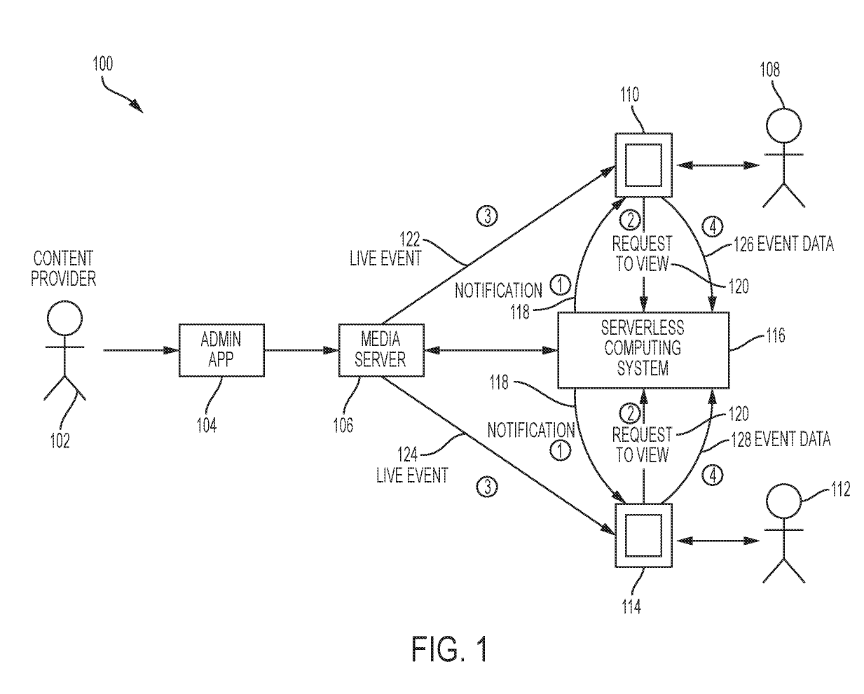

FIG. 1 illustrates an example system embodiment 100, illustrating how a serverless computing system 116 can be used to communicate live streaming content from a content provider 102 to end users 108, 112. For clarity of explanation, numerals (1)-(4) are illustrated and described below, the numerals showing the order of communications for subscribers seeking to view the live streaming content. In this example, the content provider 102 can be a celebrity or an individual wishing to stream to a subscribing audience. In other configurations, the content provider 102 can be a representative of a business, a team (such as a sports team), a brand, a government entity, or other organizations.

The content provider 102 uses administrative software (such as an admin app 104) to begin recording the live content. The live content can be, for example, live audio, live video, or combinations thereof. The admin app 104 can be, for example, used on a device associated with the content provider 102. Examples of a device from which the content provider 102 streams the content using the admin app 104 can include smartphones, tablets, laptops, computers, smart wearables (such as smart watches, smart ear pieces, smart glasses, smart contacts, etc.).

The admin app 104 streams the live content to a media server 106, which in turn contacts the serverless computing system 116. In other configurations, the admin app 104 contacts the serverless computing system 116. The serverless computing system 116 sends a notification (1) 118 to devices 110, 114. Roughly concurrent with, or just prior to, the distribution of the notifications 118, the serverless computing system 116 is going to initiate the live event on each user device 110, 114, such that when the users 108, 112 open through their notification, a player is already open playing the live content. The event instance on the user's device 110, 114 will tell a content player which resides in the app to open and begin playing back the live stream on user request. Different players can be invoked for live stream playback on different app platforms (iOS, Android, etc.). The devices 110, 114 can, for example, be mobile devices (such as smartphones, tablets, laptops, computers, or smart wearables) associated with respective users 108, 112. The notification 118 sent can be directed to particular devices 110, 114 because respective users 108, 112 associated with the devices 110, 114, had previously downloaded an app or otherwise requested to receive notifications.

The notification 118 can be sent by the serverless computing system 116 operating the subscription service as a push notification, an email, a text (SMS) message, or other similar option. In some configurations, the users 108, 112 can select to receive notifications for particular types of live events. For example, users 108, 112 may select to receive notifications for live video, but not receive notifications for live audio. Other types of event notifications a user could opt in/out of include posts associated with specific brands, people, events, actions, or behaviors.

As the devices 110, 114 receive the notifications 118, the respective users 108, 112 can select to begin viewing the live content the content provider 102 is creating. At this point, the serverless computing system 116 has already initiated a content player within the consumer app on each device 110, 114. In some configurations, opening the live content player can cause a subscription check, or ‘request to view’ (2) 120, to be sent from the mobile devices 110, 114 to the severless computing system 116. In other configurations, no such request to view (2) 120 is made. A user 108 who is not a subscriber will be receiving a reduced (thumbnail) version of the live event 122, which upon trying to open will direct the user to a subscription screen. A user 112 who already is a subscriber can immediately open the full version of the live event 124.

As the devices 110, 114 receive the streaming live content 122, 124, the respective devices 110, 114 report event data 126, 128 to the serverless computing system 116 operating the subscription service. Exemplary event data can include reports on what percentage of data is being accurately received by the end user device(s). In some configurations, this can apply to an individual device, whereas in other configurations reports reflect overall usership. For example, the event data 126, 128 could indicate that the mobile device is dropping a high number of packets or other chunks of data. Other exemplary event data can include when a user joins and what events may have helped initiate user subscriptions, what portions and what segments of the audience view which live streams events, how long the audience members have been viewing the live streaming event, at what points in a given live stream event the viewing audience drops off, the video quality being received/decoded by the respective device, and/or interactions by the audience members with the viewing app during the live event.

Because the devices 110, 114 run on different platforms, the event data 126 of one device 110 can include different types of data and be in a format distinct from the event data 128 of the second device 114. The subscription service can then normalize and aggregate the event data 126, 128 such that the combined event data can be used to provide information regarding all viewers of the live event content, rather than data specific to a single platform.

In some configurations, users 108, 112 can have the option of viewing previously recorded events which are stored in the media server 106. Such events may be uncut and as originally presented, or the recorded events may be edited. In such instances, the event data 126, 128 process is implemented as described above, with the serverless computing system 116 receiving information about how the recorded event is being received in a platform specific manner, then normalizing the event data, thereby creating multi-platform event data.

In both live and previously recorded scenarios, when the event data indicates that the content is not being received properly by the multiple user devices 110, 114, or when the media server 106 identifies that the original content being streamed from the content provider 102 is not being properly received by multiple user devices 110, 114, the media server 106 can play “filler” or place holder content. For example, if the content provider 102 is attempting to stream live video content as the content provider 102 is driving down a canyon, the signal may be poor and the media server 106 may not receive sufficient packets from the admin app 104 to maintain the video stream. In such conditions, the media server 106 can load a filler video indicating that the live video stream will return momentarily and present that filler video to the respective devices 110, 114 in the formats appropriate for each device. In another configuration, the admin app 104 can test the bandwidth currently available to the content provider 102 before beginning a live streaming event and, if the bandwidth is below a threshold amount, prohibit the content provider 102 from initiating the live event.

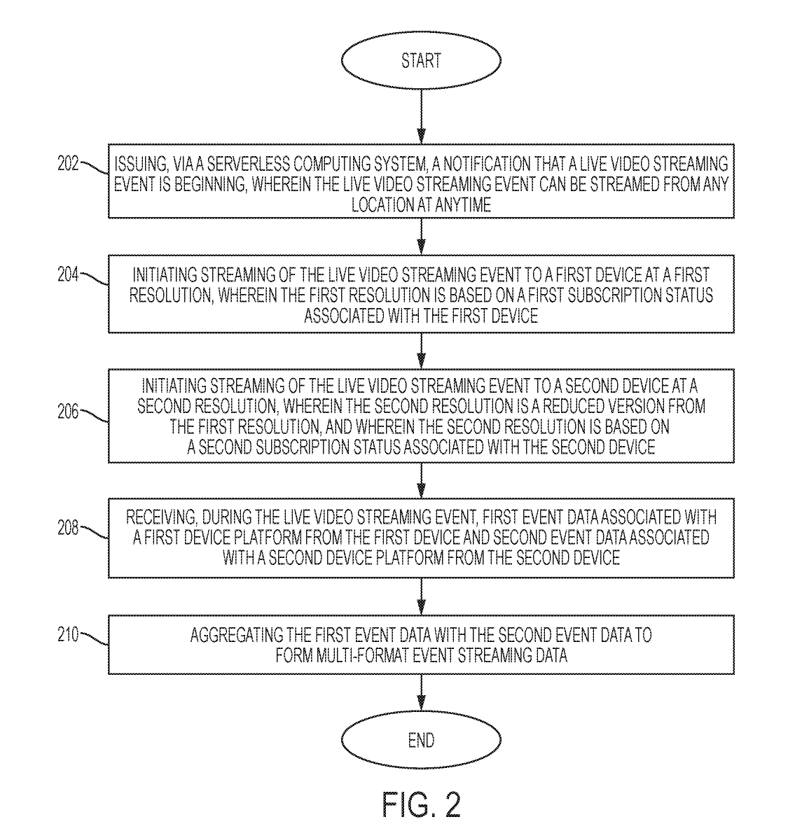

FIG. 2 illustrates an example method embodiment from the perspective of the serverless computing system 116 of FIG. 1. This subscription service can, for example, be operated by the serverless computing system 116. In this example, the serverless computing system 116 issues a notification that a live video streaming event is beginning, where the live video streaming event can be streamed from any location at anytime (202). Regardless of whether the notification is accepted, the serverless computing system 116 can initiate streaming of the live video streaming event to a first device at a first resolution, wherein the first resolution is based on a first subscription status associated with the first device (204). Likewise, the serverless computing system 116 can also initiate streaming of the live video streaming event to a second device at a second resolution, wherein the second resolution is a reduced version from the first resolution (such as a thumbnail resolution), and wherein the second resolution is based on a second subscription status associated with the second device (206). This second resolution can be selected, for example, because the user associated with the second device is not yet a subscriber.

The serverless computing system 116 can then receive, during the live video streaming event, first event data associated with a first device platform from the first device and second event data associated with a second device platform from the second device (208). Finally, the serverless computing system 116 can aggregate the first event data with the second event data to form multi-format event streaming data (210).

In certain combinations, the method can further include identifying in the multi-format event streaming data an error indicating the first device and the second device are not receiving the live video streaming event, causing transmission of the live video streaming event to pause until the error is resolved, and, during the pause, causing transmission of a filler video to the first device and the second device. The filler video can, for example, be pre-recorded. Implementations of filler content are done on a global for then entire audience, and are not performed on an individual device basis.

The notification which the serverless computing system 116 sends out can be a push notification, where a notification appears on the home screen of a mobile device, or can be a text (SMS) message, a multi-media message, an email, a tweet, or any other mechanism informing users that a live event is about to begin.

While in some circumstances samples of the live video content may be provided to non-subscribers, the full live-streaming experience is only available to subscribers. When a non-subscriber device is detected as trying to access the live stream, that device can be redirected to a sign-up page for the subscription service. For example, in such a scenario, the method could further include: receiving, based on the notification, a request from the second device to view the live video streaming event at the first resolution, and upon receiving a subscription from the second device, upgrading the content being streamed to the second device from the second resolution to the first resolution. This subscription status can then provide the second device unfettered access to live streams and other premium content and features. In addition to allowing the user to view the live stream, activating a subscription in this manner also subscription under these conditions records the live event as the “trigger” that led to the subscription conversion of this particular user.

While in many cases the live stream events discussed herein will be a single source (i.e., a single camera, or a single microphone), in some configurations multiple input devices can be used for the content providers to stream content as a live stream event. For example, the live video streaming event can be a multi-camera live stream.

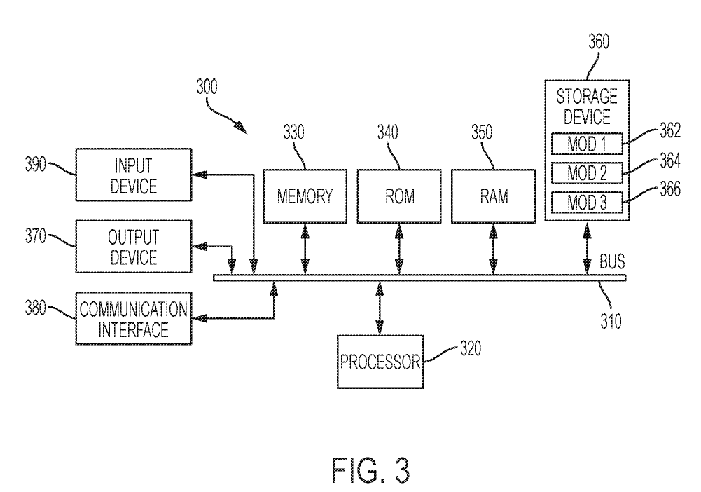

With reference to FIG. 3, an exemplary system 300 includes a general-purpose computing device 300, including a processing unit (CPU or processor) 320 and a system bus 310 that couples various system components including the system memory 330 such as read only memory (ROM) 340 and random access memory (RAM) 350 to the processor 320. The system 300 can include a cache 322 of high speed memory connected directly with, in close proximity to, or integrated as part of the processor 320. The system 300 copies data from the memory 330 and/or the storage device 360 to the cache 322 for quick access by the processor 320. In this way, the cache provides a performance boost that avoids processor 320 delays while waiting for data. These and other modules can control or be configured to control the processor 320 to perform various actions. Other system memory 330 may be available for use as well. The memory 330 can include multiple different types of memory with different performance characteristics. It can be appreciated that the disclosure may operate on a computing device 300 with more than one processor 320 or on a group or cluster of computing devices networked together to provide greater processing capability. The processor 320 can include any general purpose processor and a hardware module or software module, such as Mod 1 362, Mod 2 364, and Mod 3 366 stored in storage device 360, configured to control the processor 320 as well as a special-purpose processor where software instructions are incorporated into the actual processor design. The processor 320 may essentially be a completely self-contained computing system, containing multiple cores or processors, a bus, memory controller, cache, etc. A multi-core processor may be symmetric or asymmetric.

The system bus 310 may be any of several types of bus structures including a memory bus or memory controller, a peripheral bus, and a local bus using any of a variety of bus architectures. A basic input/output (BIOS) stored in ROM 340 or the like, may provide the basic routine that helps to transfer information between elements within the computing device 300, such as during start-up. The computing device 300 further includes storage devices 360 such as a hard disk drive, a magnetic disk drive, an optical disk drive, tape drive or the like. The storage device 360 can include software modules 362, 364, 366 for controlling the processor 320. Other hardware or software modules are contemplated. The storage device 360 is connected to the system bus 310 by a drive interface. The drives and the associated computer-readable storage media provide nonvolatile storage of computer-readable instructions, data structures, program modules and other data for the computing device 300. In one aspect, a hardware module that performs a particular function includes the software component stored in a tangible computer-readable storage medium in connection with the necessary hardware components, such as the processor 320, bus 310, output device 170 (such as a display), and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 300 is a small, handheld computing device, a desktop computer, or a computer server.

Although the exemplary embodiment described herein employs the hard disk 360, other types of computer-readable media which can store data that are accessible by a computer, such as magnetic cassettes, flash memory cards, digital versatile disks, cartridges, random access memories (RAMs) 350, and read only memory (ROM) 340, may also be used in the exemplary operating environment. Tangible computer-readable storage media, computer-readable storage devices, and/or computer-readable memory devices, expressly exclude media such as transitory waves, energy, carrier signals, electromagnetic waves, and signals per se.

To enable user interaction with the computing device 300, an input device 390 represents any number of input mechanisms, such as a microphone for speech, a touch-sensitive screen for gesture or graphical input, keyboard, mouse, motion input, speech and so forth. An output device 370 can also be one or more of a number of output mechanisms known to those of skill in the art. In some instances, multimodal systems enable a user to provide multiple types of input to communicate with the computing device 300. The communications interface 380 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 320. The functions these blocks represent may be provided through the use of either shared or dedicated hardware, including, but not limited to, hardware capable of executing software and hardware, such as a processor 320, that is purpose-built to operate as an equivalent to software executing on a general purpose processor. For example the functions of one or more processors presented in FIG. 3 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 340 for storing software performing the operations described below, and random access memory (RAM) 350 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 300 shown in FIG. 3 can practice all or part of the recited methods, can be a part of the recited systems, and/or can operate according to instructions in the recited tangible computer-readable storage media. Such logical operations can be implemented as modules configured to control the processor 320 to perform particular functions according to the programming of the module. For example, FIG. 3 illustrates three modules Mod 1 362, Mod 2 364 and Mod 3 366 which are modules configured to control the processor 320. These modules may be stored on the storage device 360 and loaded into RAM 350 or memory 330 at runtime or may be stored in other computer-readable memory locations.

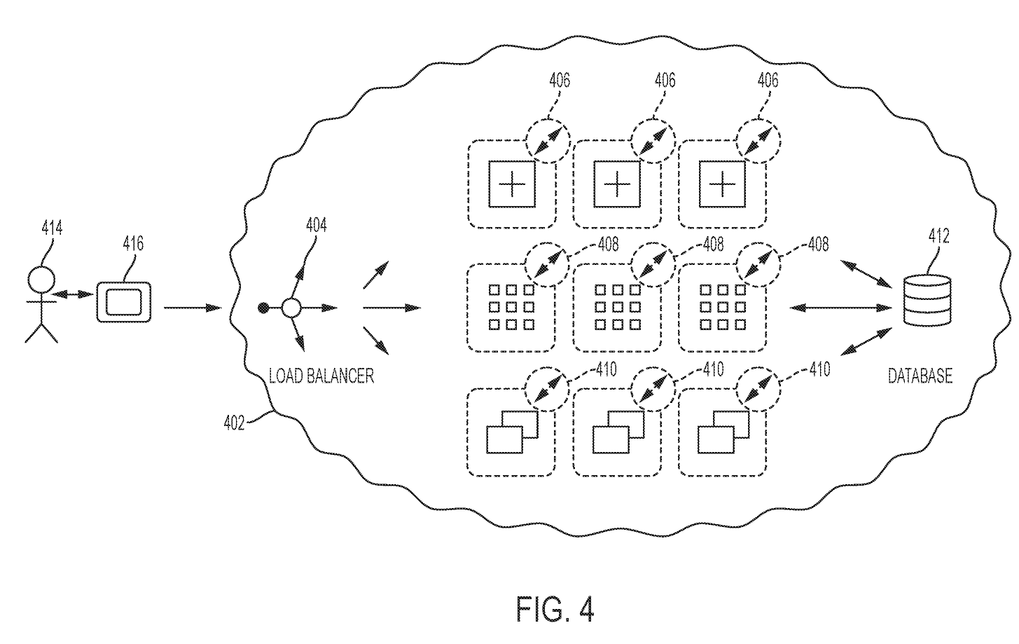

FIG. 4 illustrates an exemplary “serverless” microservices architecture capable of running the serverless computing system 116 architecture of FIG. 1. In this example, the microservices architecture is operated by a web service operating in the cloud 402 (such as AMAZON Web Services) on a network of addressable nodes. The web service may be a single Internet site, multiple servers, or other user interface offered over a network. The web service may be implemented using multiple microservices that may be responsible for handling individual aspects of the overall web service, where the users/developers determine which functions need to be implemented by the web service. For example, a subscriber service such as described herein can perform operations such as subscriber authentication and access control, subscription conversion, onboarding, capturing engagement activity, capturing QoS data from the live event across a wide range of devices, receiving event data from individual subscribers, verifying subscriber statuses, etc., by disparate microservices from different addressable nodes within the web service. Each addressable node may be an active electronic device (such as a server or other computing device) that is attached to a network, and is capable of sending, receiving, processing, or forwarding information over a communications channel.

The microservices architecture may include load balancer 404 for routing a request from one addressable node to one or more virtual addresses, where the virtual addresses can respectively correspond to microservices 406, 408, 410. The load balancer 404 may be an addressable node as well, or it may simply be software executing on an addressable node. The virtual addresses may be associated with the load balancer 404, and each virtual address may correspond to a unique microservice 406, 408, 410. A microservice may be any type of software service offered by a node on the network 101. In this exemplary architecture, virtual addresses are associated with microservices 406, 408, 410, respectively. The system 100 also comprises one or more physical nodes. The physical nodes may be implemented using any desired computing device, such as a network server, personal computer, or other device per the description provided in FIG. 4. Each physical node can support one or more of the microservices by executing software associated with the microservice.

In one example, a single physical node can support microservices 406, 408, while a distinct physical node supports microservices 410. Each of the microservices 406, 408, 410 can be associated with a virtual address, which in turn can be associated with a physical node. Requests for the service of a particular microservice 406, 408, 410 may be addressed to the virtual address associated with the desired microservice.

Because the microservices 406, 408, 410 are provided by a web service on the cloud 402, such services are also described as “serverless.” While servers may be used by the web service to perform the desired operations, and may be informed which operations to perform by a central server (such as the load balancer 404 or a subscription service specific server for load balancing), the microservices architecture is described as serverless because the users of such services do not own, maintain, or otherwise have access to the servers used for the processing. Instead of paying to configure, upgrade, and otherwise maintain a server farm to host their operations, the users of serverless systems pay the web service for time when a processor is actually performing the desired operations (many web services also charge for other miscellaneous operations, such as uploading a new function or operation).

By not owning the servers which are performing the operations, the managers of applications which utilize serverless architectures can save money and resources because they are only paying for when operations are actually occurring, and not paying for servers when operations are idling. In addition, the serverless architecture can allow scaling of resources based on demand. For example, in a traditional server-farm architecture, each server may be configured to handle a single iteration or operation of functions 406, 408, 410. However, there may be instances where demand for a single type of operation is high, such as when many users are registering for a subscription service. When demand for operations outstrips the resources available (i.e., the number of servers owned, or the capacity of those servers), the website or application crashes. By contrast, in a serverless environment, resources are allocated based on demand, such that a subscription service makes demand of a single execution of a first operation type 406, no executions of a second operation type 408, and many executions of a third operations type 410. As demand increases for the third operations type 410, the number of demands for operations may exceed the number of operations any single server would be capable of executing. To compensate for this, the web service can use the load balancer 404 to shift operations between multiple servers. Each server can be communicating with a database 412 or databases to store data associated with the operations and/or a record of the operations.

Consider the example of implementing the live video streaming method of FIG. 2 in the serverless architecture of FIG. 4. In an enterprise or commercial platform-as-a-service computing models (as described above), marketers of digital content subscription services who might wish to launch a video commenting feature would need to provision and maintain a level of system performance, reliability, and quality for each component in the delivery process—uploading, transcoding, moderating, publishing, and distribution—that would support both average and burst/peak utilization on a 24/7/365 basis. Such an approach may not be the most efficient, because much of the aggregated paid capacity of the system will be unutilized when no content providers are streaming live events.

By contrast, with the micro-serverless subscription service such as that illustrated in FIG. 4, system capacity and performance can be triggered by events, such as a content provider beginning to stream live content. The initiation of a live event spawns a set of events performed by the serverless architecture. For example, as the live streaming event begins, notifications must be sent out, subscription statuses verified, event data received in multiple formats, and the event data formatted/normalized into a multi-platform format.

In this manner, the subscription service can scale upwards and downwards as events initiate and end. This kind of event-driven, near real-time workflow is exemplary not only of the remaining portions of publishing a live streaming events, but of all features supported by a micro-serverless subscription service in general. Besides supporting functionality as described here, and in addition to supporting a more efficient use of computing resources, the event stream generated by user and system actions within the micro-serverless subscription service can be harnessed to provide a rich environment for analytics, operations/processes, and data mining.

The steps and services outlined herein are exemplary and can be implemented in any combination thereof, including combinations that exclude, add, or modify certain steps.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
issuing, via a serverless computing system, a notification that a live video streaming event is beginning, wherein the live video streaming event can be streamed from any location at anytime;
initiating streaming of the live video streaming event to a first device at a first resolution, wherein the first resolution is based on a first subscription status associated with the first device;
initiating streaming of the live video streaming event to a second device at a second resolution, wherein the second resolution is a reduced version from the first resolution, and wherein the second resolution is based on a second subscription status associated with the second device; receiving, during the live video streaming event, first event data associated with a first device platform from the first device and second event data associated with a second device platform from the second device; and
aggregating the first event data with the second event data to form multi-format event streaming data.

2. The method of claim 1, further comprising:
identifying in the multi-format event streaming data an error indicating the first device and the second device are not receiving the live video streaming event;
causing transmission of the live video streaming event to pause until the error is resolved; and
during the pause, causing transmission of a filler video to the first device and the second device.

3. The method of claim 2, wherein the filler video is pre-recorded.

4. The method of claim 1, wherein the notification is a push notification.

5. The method of claim 1, further comprising:
receiving, from the second device, a subscription request; and
upgrading the second resolution to equal the first resolution.

6. The method of claim 1, wherein the live video streaming event is a multi-camera live stream.

7. The method of claim 1, wherein the first event data contains distinct data classifications than the second event data, and wherein the multi-format event streaming data is normalized between the first event data and the second event data.

8. The method of claim 1, wherein the first format and the second format are determined, at least in part, according to a type of device of through which the first request and the second request are respectively made.

9. The method of claim 1, wherein the serverless computing system operates the subscription service.

10. The method of claim 9, wherein the subscription service pays a web service for processing time.

11. A serverless subscription service configured to perform operations, the operations comprising:
issuing a notification that a live video streaming event is beginning, wherein the live video streaming event can be streamed from any location at anytime;
initiating streaming of the live video streaming event to a first device at a first resolution, wherein the first resolution is based on a first subscription status associated with the first device;
initiating streaming of the live video streaming event to a second device at a second resolution, wherein the second resolution is a reduced version from the first resolution, and wherein the second resolution is based on a second subscription status associated with the second device;
receiving, during the live video streaming event, first event data associated with a first device platform from the first device and second event data associated with a second device platform from the second device; and
aggregating the first event data with the second event data to form multi-format event streaming data.

12. The serverless subscription service of claim 11, the operations further comprising:
identifying in the multi-format event streaming data an error indicating the first device and the second device are not receiving the live video streaming event;
causing transmission of the live video streaming event to pause until the error is resolved; and
during the pause, causing transmission of a filler video to the first device and the second device.

13. The serverless subscription service of claim 12, wherein the filler video is pre-recorded.

14. The serverless subscription service of claim 11, wherein the notification is a push notification.

15. The serverless subscription service of claim 11, the operations further comprising:
receiving, from the second device, a subscription request; and
upgrading the second resolution to equal the first resolution.

16. The serverless subscription service of claim 11, wherein the live video streaming event is a multi-camera live stream.

17. The serverless subscription service of claim 11, wherein the first event data contains distinct data classifications than the second event data, and wherein the multi-format event streaming data is normalized between the first event data and the second event data.

18. The serverless subscription service of claim 11, wherein the first format and the second format are determined, at least in part, according to a type of device of through which the first request and the second request are respectively made.

19. The serverless subscription service of claim 11, wherein the notification is sent to devices based on event type preferences set on respective devices.

20. The serverless subscription service of claim 19, wherein the subscription service pays a web service for processing time.
